(19) United States
(12) Patent Application Publication
(10) Pub. No.: US 2019/0320652 A1
(43) Pub. Date: Oct. 24, 2019

(54) INSECT PEST CONTROL PRODUCT AND INSECT PEST CONTROL METHOD

(71) Applicant: DAINIHON JOCHUGIKU Co., Ltd., Osaka (JP)

(72) Inventors: Taisuke ITANO, Osaka (JP); Yumiko ICHIMURA, Osaka (JP); Seiichi KASHIMA, Osaka (JP); Tomoyuki HIKITSUCHI, Osaka (JP); Koji NAKAYAMA, Osaka (JP)

(21) Appl. No.: 16/475,397

(22) PCT Filed: Dec. 26, 2017
(86) PCT No.: PCT/JP2017/046609

§ 371 Date: Jul. 2, 2019

(30) Foreign Application Priority Data
Jan. 6, 2017 (JP) 2017-000900

(51) Int. Cl. A01N 25/18; A01N 53/00; A01M 1/20

(52) U.S. Cl. CPC A01N 25/18; A01M 1/2066; A01N 53/00

(57) ABSTRACT

Provided is an insect pest control product capable of effectively controlling flying insect pests. An insect pest control product comprising a thermal vaporization/diffusion absorbent wick for vaporizing and diffusing a water-based insecticidal composition containing a pyrethroid insecticidal component having a vapor pressure of 2×10⁻⁴ to 1×10⁻² mmHg at 30° C., a glycol ether compound and/or glycol compound having a boiling point of 150-300° C., and water, wherein a concentration of the pyrethroid insecticidal component in diffused vapor particles one hour after the start of vaporization and diffusion is 1.5-18 times as high as a concentration of the pyrethroid insecticidal component in diffused vapor particles immediately after the start of vaporization and diffusion.

### TECHNICAL FIELD

The present invention relates to an insect pest control product comprising a thermal vaporization/diffusion absorbent wick for use in vaporization and diffusion of a water-based insecticidal composition containing a pyrethroid insecticidal component having a relatively high vapor pressure, and an insect pest control method.

Among flying insect pest control products for controlling flying insect pests such as mosquitoes are so-called “liquid mosquito killers,” which are commercially available. Liquid mosquito killers utilize the technique of putting an absorbent wick in a chemical liquid containing an insecticidal component so that the chemical liquid is absorbed and transported to the top portion of the absorbent wick, and heating the absorbent wick so that the insecticidal component is vaporized and diffused into the atmosphere. The insecticidal component for liquid mosquito killers is typified by pyrethroid insecticidal components. Allethrin, prallethrin, furamethrin, etc., are conventionally the most commonly used pyrethroid insecticidal components, but lately there is a trend towards using newer pyrethroid insecticidal components such as transfluthrin, metofluthrin, and profluthrin, which have a higher insecticidal activity.

Among chemical liquids for use in liquid mosquito killers are kerosene-based formulations (referred to as “oil-based formulations”) and water-based formulations. So far oil-based formulations have been used in most of globally available liquid mosquito killers. However, water-based formulations can have a lower risk of catching fire and can be easily made more effective in killing insect pests, compared to oil-based formulations. Therefore, it is envisaged that the demand for water-based formulations will increasingly grow in future.

Among conventional water-based flying insect pest control products is a thermal vaporization/diffusion water-based insecticide employing a chemical liquid containing a pyrethroid insecticidal component, a surfactant, and water (see, for example, Patent Document 1). In the case of a thermal vaporization/diffusion water-based insecticide disclosed in Patent Document 1, the chemical liquid is vaporized and diffused using a thermal vaporization/diffusion absorbent wick. The surfactant contained in the chemical liquid acts to maintain the proportions of the components of the chemical liquid so that the pyrethroid insecticidal component can be stably vaporized and diffused over a long period of time.

### CITATION LIST

### Patent Literature

Patent Document 1: Japanese Unexamined Patent Application Publication No. H03-7207

### SUMMARY OF INVENTION

### Technical Problem

When a flying insect pest control product is used indoors, it is necessary to suitably adjust the concentration of the pyrethroid insecticidal component contained in vapor particles diffused from the flying insect pest control product in order to effectively enhance the action of the pyrethroid insecticidal component to control flying insect pests. To do so, it is necessary to determine the concentration of the pyrethroid insecticidal component contained in the diffused vapor particles, and understand a relationship between a change in the concentration and the control effect. However, because pyrethroid insecticidal components such as transfluthrin, metofluthrin, and profluthrin have a relatively high vapor pressure, it is particularly difficult to adjust the concentration of such a pyrethroid insecticidal component in a flying insect pest control product employing a water-based chemical liquid.

In this regard, in the case of the thermal vaporization/diffusion water-based insecticide of Patent Document 1, vaporization/diffusion stability is enhanced by addition of a surfactant, and an attempt is made to maintain the concentration of the pyrethroid insecticidal component constant. In the conventional art including Patent Document 1, there is no flying insect pest control product developed based on the idea of adjusting the concentration of the pyrethroid insecticidal component contained in the diffused vapor particles.

With the above problem in mind, the present invention has been made. The present inventors have focused attention to a change in the concentration of the pyrethroid insecticidal component contained in the diffused vapor particles. It is an object of the present invention to provide an insect pest control product that comprises a thermal vaporization/diffusion absorbent wick which can be used for vaporization/diffusion of a chemical liquid containing a pyrethroid insecticidal component having a relatively vapor pressure, and that can effectively control flying insect pests. It is another object of the present invention to provide an insect pest control method that can be carried out using such an insect pest control product.

### Solution to Problem

A characteristic feature of an insect pest control product according to the present invention for achieving the object, is an insect pest control product comprising a thermal vaporization/diffusion absorbent wick for vaporizing and diffusing a water-based insecticidal composition containing a pyrethroid insecticidal component having a vapor pressure of 2×10⁻⁴ to 1×10⁻² mmHg at 30° C., a glycol ether compound and/or glycol compound having a boiling point of 150-300° C., and water, wherein a concentration of the pyrethroid insecticidal component in diffused vapor particles one hour after the start of vaporization and diffusion is 1.5-18 times as high as a concentration of the pyrethroid insecticidal component in diffused vapor particles immediately after the start of vaporization and diffusion.

In the insect pest control product thus configured, the water-based insecticidal composition contains suitable components and has suitable characteristics, and the pyrethroid insecticidal component contained in diffused vapor particles of the water-based insecticidal composition is effectively concentrated one hour after the start of vaporization and diffusion, and therefore, an excellent flying insect pest control effect can be sustained over a long period of time.

In the insect pest control product of the present invention, the diffused vapor particles one hour after the start of vaporization and diffusion preferably have an average particle size of 0.2-2.5 μm.

In the insect pest control product thus configured, diffused vapor particles having a suitable average particle size are formed one hour after the start of vaporization and diffusion, and therefore, a more excellent flying insect pest control effect is obtained.

In the insect pest control product of the present invention, the glycol ether compound is preferably diethylene glycol monoalkyl ether.

In the insect pest control product thus configured, the glycol ether compound is diethylene glycol monoalkyl ether, and therefore, an excellently sustainable flying insect pest control effect is obtained.

In the insect pest control product of the present invention, the pyrethroid insecticidal component is preferably at least one selected from the group consisting of transfluthrin, metofluthrin, and profluthrin.

In the insect pest control product thus configured, a suitable pyrethroid insecticidal component is used, and therefore, a more excellent flying insect pest control effect is obtained.

The insect pest control product of the present invention preferably further comprises a hollow tube-shaped heat generator for heating the thermal vaporization/diffusion absorbent wick with the heat generator surrounding the absorbent wick, wherein a height of a region where an outer surface of the thermal vaporization/diffusion absorbent wick and an inner surface of the hollow tube-shaped heat generator face each other is preferably set to 0.2-0.8 times as great as a length of the hollow tube-shaped heat generator.

In the insect pest control product thus configured, the thermal vaporization/diffusion absorbent wick is heated by the hollow tube-shaped heat generator, and the height of the region where the outer surface of the thermal vaporization/diffusion absorbent wick and the inner surface of the hollow tube-shaped heat generator face each other is set to 0.2-0.8 times as great as the length of the hollow tube-shaped heat generator. Therefore, variations in the particle size of vapor particles vaporized and diffused from the thermal vaporization/diffusion absorbent wick are reduced, and as a result, the sustainability of the flying insect pest control effect can be further improved.

In the insect pest control product of the present invention, a surface temperature of the hollow tube-shaped heat generator is preferably set to 80-150° C., and an average gap distance between an outer surface of the thermal vaporization/diffusion absorbent wick and an inner surface of the hollow tube-shaped heat generator is preferably set to 1.2-1.8 mm.

In the insect pest control product thus configured, the surface temperature of the hollow tube-shaped heat generator, and the average gap distance between the outer surface of the thermal vaporization/diffusion absorbent wick and the inner surface of the hollow tube-shaped heat generator, are suitably set, and therefore, high-quality diffused vapor particles can be generated, and the sustainability of the flying insect pest control effect can be further improved.

In the insect pest control product of the present invention, a length of the hollow tube-shaped heat generator is preferably set to 8-12 mm.

In the insect pest control product thus configured, the length of the hollow tube-shaped heat generator is suitably set, and therefore, the flying insect pest control effect and the sustainability are well balanced.

In the insect pest control product of the present invention, the thermal vaporization/diffusion absorbent wick is preferably a baked wick, a porous ceramic wick, a felt wick, or a braided wick.

In the insect pest control product thus configured, the thermal vaporization/diffusion absorbent wick is made of a suitable material, and therefore, an excellent flying insect pest control effect is obtained, and high durability is imparted to the insect pest control product.

In the insect pest control product of the present invention, the water-based insecticidal composition vaporized and diffused from the thermal vaporization/diffusion absorbent wick preferably prevents a flying insect pest from entering a room from the outside of the room.

In the insect pest control product thus configured, the vaporized and diffused water-based insecticidal composition (diffused vapor particles) contains an effective amount of the pyrethroid insecticidal component, and therefore, opportunities of contacting flying insect pests are increased, and the effect of preventing flying insect pests from entering is enhanced. Therefore, for example, even when applied to a space of a room with an open window or door in a side wall thereof, the insect pest control product can effectively prevent flying insect pests from entering the room space from the outside of the room.

In the insect pest control product of the present invention, the insect pest control product preferably prevents a flying insect pest from entering a room of at least 25 m³ from the outside of the room for 30-90 days.

The insect pest control product thus configured has the above performance, and therefore, may be a practical insect pest control product.

A characteristic feature of an insect pest control method according to the present invention for achieving the above object is an insect pest control method of using any one of the above insect pest control products, comprising putting the thermal vaporization/diffusion absorbent wick in the water-based insecticidal composition so that the water-based insecticidal composition is absorbed and transported to a top portion of the thermal vaporization/diffusion absorbent wick, and heating the top portion of the thermal vaporization/diffusion absorbent wick at 80-150° C. so that the pyrethroid insecticidal component is vaporized and diffused into the atmosphere.

In the present invention insect pest control method, the insect pest control product of the present invention is used to vaporize and diffuse the water-based insecticidal composition, and therefore, an excellent flying insect pest control effect can be sustained over a long period of time.

### DESCRIPTION OF EMBODIMENTS

An insect pest control product and insect pest control method according to the present invention will now be described. Note that the present invention is in no way intended to be limited to embodiments or examples described below.

A water-based insecticidal composition for a liquid mosquito killer (hereinafter referred to as an “water-based insecticidal composition”) applicable to the insect pest control product of the present invention contains a pyrethroid insecticidal component having a vapor pressure of 2×10⁻⁴ to 1×10⁻² mmHg at 30° C. Examples of such a pyrethroid insecticidal component include transfluthrin, metofluthrin, profluthrin, empenthrin, terallethrin, meperfluthrin, heptafluthrin, 4-methoxymethyl-2,3,5,6-tetrafluorobenzyl-chrysanthemate, and 4-methoxymethyl-2,3,5,6-tetrafluorobenzyl-2,2-dimethyl-3-(2-chloro-2-trifluoromethylvinyl)cyclopropane carboxylate. Of them, transfluthrin, metofluthrin, and profluthrin are preferable, and transfluthrin is more preferable, in terms of thermal vaporization and diffusion capability, insect killing efficacy, stability, etc. The above pyrethroid insecticidal components may be used alone or in combination. If there are optical or geometrical isomers based on asymmetric carbon for the acid moiety or alcohol moiety of the pyrethroid insecticidal component, these pyrethroid insecticidal component isomers can be used in the present invention.

The content of the pyrethroid insecticidal component in the water-based insecticidal composition is preferably 0.1-3.0 mass %. If the content is less than 0.1 mass %, the insect killing efficacy is likely to be low. Meanwhile, if the content is more than 3.0 mass %, the properties of the water-based insecticidal composition are likely to be impaired.

The water-based insecticidal composition is a water-based formulation, and therefore, water is used as a solvent for the water-based insecticidal composition. The water-based formulation can have a lower risk of catching fire and can be easily made more effective in killing insect pests, compared to oil-based formulations. In order to enable the insecticidal composition to be a water-based formulation, the insecticidal composition preferably contains a glycol ether compound and/or glycol compound having a boiling point of 150-300° C., preferably 200-260° C., together with the pyrethroid insecticidal component and water. The present invention is premised on the feature that the glycol ether compound and/or glycol compound have the following actions: (1) solubilizing the pyrethroid insecticidal component; (2) having thermal vaporization and diffusion capability; and (3) mediating between the pyrethroid insecticidal component and water so that the three components are thermally vaporized and diffused from an absorbent wick while the ratio of the three components is maintained constant. In this regard, in order to achieve the object of the present invention, it is important to cause diffused vapor particles formed by vaporization and diffusion of the water-based insecticidal composition containing the above three components to behave such that the particles have increased opportunities of contacting flying insect pests and an enhanced effect of preventing flying insect pests from entering indoors. One of the factors in inducing such behavior is, for example, the average particle size of the diffused vapor particles. In general, diffused vapor particles of a water-based formulation tend to have a smaller average particle size in the case where a compound contained in the particle has a lower boiling point, and to have a large average particle size in the case where the compound has a higher boiling point. The water-based insecticidal composition used in the present invention contains the above three components in suitable proportions, and the average particle size of the diffused vapor particles does not depend only on the boiling point of the glycol ether compound and/or glycol compound. However, in order to achieve the above behavior, as the glycol ether compound and/or glycol compound, one that has the above boiling point (150-300° C., preferably 200-260° C.) is selected.

The content of the glycol ether compound and/or glycol compound in the water-based insecticidal composition is preferably 10-70 mass %, more preferably 30-60 mass %. If the content is less than 10 mass %, not only is it difficult to prepare a water-based formulation of the water-based insecticidal composition, but also the sustainability of the flying insect pest control effect is poor. Meanwhile, if the content is more than 70 mass %, not only are the effect of killing flying insect pests and the effect of preventing flying insect pests from entering indoors no longer enhanced, but also the risk of catching fire increases, and therefore, the advantage of being a water-based formulation is likely to be impaired.

Examples of the glycol ether compound and/or glycol compound include diethylene glycol monoethyl ether (boiling point: 202° C.), diethylene glycol monoisopropyl ether (boiling point: 207° C., hereinafter referred to as “DEMIP”), diethylene glycol monobutyl ether (boiling point: 231° C., hereinafter referred to as “DEMB”), diethylene glycol monoisobutyl ether (boiling point: 220° C., hereinafter referred to as “DEMIB”), diethylene glycol monohexyl ether (boiling point: 259° C., hereinafter referred to as “DEMH”), diethylene glycol mono2-ethylhexyl ether (boiling point: 272° C.), diethylene glycol monophenyl ether (boiling point: 283° C., hereinafter referred to as “DEMPh”), triethylene glycol monomethyl ether (boiling point: 249° C.), propylene glycol mono-tertiary butyl ether (boiling point: 151° C.), dipropylene glycol monomethyl ether (boiling point: 188° C.), dipropylene glycol monopropyl ether (boiling point: 210° C., hereinafter referred to as “DPMP”), 3-methoxy-1,2-propanediol (boiling point: 220° C.), and hexylene glycol (boiling point: 197° C., hereinafter referred to as “HG”). Of them, diethylene glycol monoethyl ether, diethylene glycol monoisopropyl ether, diethylene glycol monobutyl ether, diethylene glycol monoisobutyl ether, and diethylene glycol monohexyl ether are preferable, and diethylene glycol monobutyl ether is more preferable. The above glycol ether compounds and/or glycol compounds may be used alone or in combination.

Various other components may be added to the water-based insecticidal composition. For example, other pyrethroid insecticidal components such as allethrin and prallethrin, repellent components such as DEET, terpene compounds, and natural essential oils, antibacterial agents, antifungal agents, stabilizers such as dibutylhydroxytoluene (BHT) and methyl parahydroxybenzoate, pH adjusting agents, coloring agents, deodorants such as tea extracts and tea leaf dry distilled solutions, etc., may be added as appropriate. In preparation of the water-based insecticidal composition, lower alcohols such as ethanol and isopropanol, hydrocarbon solvents such as kerosene, ester or ether solvents, solubilizers, and dispersants may be used as appropriate in amounts such that the advantages of the water-based formulation are not impaired.

The water-based insecticidal composition thus prepared is placed in a container body (not shown) equipped with a thermal vaporization/diffusion absorbent wick, so that an insect pest control product (liquid mosquito killer) according to the present invention is constructed. The insect pest control product of the present invention is characterized by being configured such that the concentration of the pyrethroid insecticidal component contained in diffused vapor particles one hour after the start of vaporization and diffusion of the water-based insecticidal composition from the thermal vaporization/diffusion absorbent wick is 1.5-18 times as high as the concentration of the pyrethroid insecticidal component contained in diffused vapor particles immediately after the start of the vaporization and diffusion, and the diffused vapor particles have an average particle size of 0.2-2.5 μm. Once such diffused vapor particles have been formed, the diffused vapor particles are carried by an air flow to form an air curtain, and exhibit behavior such that the diffused vapor particles have increased opportunities of contacting flying insect pests and an enhanced effect of preventing flying insect pests from entering indoors. As a result, even when the insect pest control product of the present invention is used in a space of a room with an open window or door in a side wall thereof, flying insect pests are effectively prevented from entering the room space from the outside of the room, and a superior flying insect pest control effect is sustained over a long period of time. Incidentally, the flying insect pest control effect of the insect pest control product of the present invention is at least sustainable for 30-90 days in a room of 6 Jyo (Jyo is a Japanese unit of area: 1 Jyo is equal to approximately 1.7 m²) (25 m³). Note that the insect pest control product is typically used for about 6-15 hours a day, although such a duration varies depending on the region or season in which the product is used.

A characteristic behavior of diffused vapor particles generated by the insect pest control product of the present invention will be more specifically described. The average particle size of diffused vapor particles of the water-based insecticidal composition is reduced from about 5 μm immediately after vaporization and diffusion to 0.2-2.5 μm, which is a particle size that allows the diffused vapor particles to easily contact flying insect pests, more preferably 0.5-2.0 μm. The concentration of the pyrethroid insecticidal component in the diffused vapor particles is adjusted such that as the average particle size decreases, the concentration increases from 0.1-3 wt %, which is the initial concentration, to 0.15-54 wt % (i.e., 1.5-18 times as high), preferably 0.2-27 wt % (i.e., 2-9 times as high). This is partly because water, which is easily vaporized and diffused, of the three components, is gradually released and diffused from the diffused vapor particles due to thermal vaporization and diffusion. Meanwhile, at least while the diffused vapor particles are suspended in a space of a room, a predetermined amount of water continues to remain in the diffused vapor particles, and therefore, characteristics of the water-based insecticidal composition are maintained until the end. In the form of the liquid mosquito killer of the present invention, these actions may synergistically interact to continuously form an air flow (air curtain) of the diffused vapor particles containing an effective amount of the pyrethroid insecticidal component at or near the inner side of a window or door, so that diffused vapor particles may have increased opportunities of contacting flying insect pests and an enhanced effect of preventing flying insect pests from entering indoors. As a result, flying insect pests may be prevented from entering indoors from the outside.

Meanwhile, the present inventors have found that in the case of a kerosene-based formulation (i.e., an oil-based formulation), the effect of killing flying insect pests is substantially similar to that of a water-based formulation, and the effect of preventing flying insect pests from entering is considerably inferior. This may, for example, be because diffused vapor particles of an oil-based formulation have an average particle size of as small as about 0.05-0.5 μm, and therefore, are easily dissipated at or near the inner side of a window or door, so that an effective air curtain is unlikely to be formed, and in addition, have a small increase in the concentration of the pyrethroid insecticidal component, whereas diffused vapor particles of a water-based formulation have a characteristic increase in the concentration of the pyrethroid insecticidal component.

The container for containing the water-based insecticidal composition is typically made of a plastic such as a polyolefin (e.g., polypropylene), a polyester, or polyvinyl chloride. An absorbent wick is attached to a top portion of the chemical liquid container through a stopper. In the case of a water-based formulation, the chemical liquid container is preferably made of a polyolefin plastic such as polypropylene, taking into account the physical properties of the glycol ether compound and/or glycol compound.

Incidentally, thermal vaporization/diffusion absorbent wicks for liquid mosquito killers are typically roughly divided into baked wicks, porous ceramic wicks, braided wicks, and bound wicks. In the present invention, baked wicks, porous ceramic wicks, felt wicks, and braided wicks are preferably used, and baked wicks or porous ceramic wicks are more preferably used. In the description that follows, a case where a baked wick or braided wick is used as the thermal vaporization/diffusion absorbent wick will be described. Note that materials for the thermal vaporization/diffusion absorbent wick are not particularly limited, if the materials are stable with respect to the water-based insecticidal composition containing the pyrethroid insecticidal component, and can absorb an aqueous solution through capillary action.

A baked wick is obtained by baking a mixture of (a) an inorganic powder, (b) an inorganic binder, and (c) an organic substance (a carbonaceous powder, an organic binder, etc.) at 600-2000° C. A wick that contains a small amount of (b) and (c) and is mostly formed of (a), is typically called a porous ceramic wick.

Examples of the inorganic powder include mica, alumina, silica, talc, mullite, cordierite, and zirconia. Of them, mica is preferable, particularly because it can impart relatively uniform fine pores to a liquid mosquito killer absorbent wick. The above inorganic powders may be used alone or in combination. The content of the inorganic powder in the thermal vaporization/diffusion absorbent wick is preferably 10-90 mass %, more preferably 30-70 mass %. The inorganic powder is preferably fine powder of 50 mesh or finer in terms of physical properties such as external appearance, liquid absorption capability, and strength, unless a treatment such as pulverization is involved in the process of producing the thermal vaporization/diffusion absorbent wick.

Examples of the inorganic binder include clays such as kaolinite, bentonite, and halloysite, tar pitch, and water glass. Of them, clays are preferable because they have good binding capability. The above inorganic binders may be used alone or in combination. The content of the inorganic binder in the thermal vaporization/diffusion absorbent wick is preferably 5-50 mass %, more preferably 10-40 mass %. The inorganic binder has poor binding action at room temperature, and acquires sufficient binding action by being baked at 600-2000° C., so that it can be preferably used in the thermal vaporization/diffusion absorbent wick.

Examples of the organic substance include carbonaceous powders such as graphite, carbon black, activated carbon, charcoal, and coke, or organic binders such as carboxymethyl cellulose (CMC), acrylic resins, and polyolefin resins. Of them, graphite is preferable because it has a relatively uniform shape and contains less impurities. By adding a carbonaceous powder such as graphite to the thermal vaporization/diffusion absorbent wick, the external appearance, color, liquid absorption capability, strength, etc., thereof can be improved. The above carbonaceous powders or organic binders may be used alone or in combination. The content of the organic substance in the thermal vaporization/diffusion absorbent wick is preferably 5-40 mass %. If the content is within this range, the generation of carbon monoxide or carbon dioxide during baking of the thermal vaporization/diffusion absorbent wick can produce continuous air holes in the thermal vaporization/diffusion absorbent wick, so that a porous structure that can exert sufficient liquid absorption performance through capillary action can be formed.

Note that, in addition to the above substances, the thermal vaporization/diffusion absorbent wick may additionally contain a preservative, and an antioxidant such as 4,4′-methylene bis(2-methyl-6-t-butylphenol) or stearyl-β-(3,5-di-t-butyl-4-hydroxyphenyl)propionate, as appropriate.

A braided wick is typically obtained by covering the outer peripheral surface of a core member with a sheath material for absorbing, vaporizing, and diffusing a water-based insecticidal composition, where the sheath material is formed as an aggregation of at least one type of fibers selected from natural fibers, synthetic fibers, and inorganic fibers. In braided wicks, the core member has the function of keeping the shape of the thermal vaporization/diffusion absorbent wick. The materials for the core member do not necessarily need to have the function of absorbing a water-based insecticidal composition. The core member may be made of, for example, a thermoplastic and/or thermosetting synthetic resin that can withstand temperatures of 130° C. or more. Note that in order to enhance the shape retaining function, the thermoplastic and/or thermosetting synthetic resin of the core member may be reinforced using a fibrous reinforcing material such as glass fiber, ceramic fiber, or carbon fiber, a powder reinforcing material such as silica, alumina, or titanium oxide, which are called a glass powder or inorganic filler, or the like.

The sheath material is typically formed as an aggregation of fibers. The fiber aggregation includes one or more types of fibers. Examples of the fibers include natural fibers such as cotton, synthetic fibers such as polypropylene, polyester, nylon, and aramid, and inorganic fibers such as glass fiber and carbon fiber. Synthetic fibers that can withstand temperatures of 130° C. or more such as polypropylene, polyester, nylon, and aramid are preferable. Such a fiber aggregation is typically made of a fiber material in the form of braid, woven fabric, knitted fabric, felt, nonwoven fabric, or the like. In this case, the fiber material may be treated with a surfactant so that the liquid absorption speed is adjusted. Furthermore, the surface of the sheath material may be covered with a varnish or the like, or may be treated so that a function such as hydrophilicity is imparted thereto.

The thermal vaporization/diffusion absorbent wick thus obtained is applied to a liquid mosquito killer in which the water-based insecticidal composition is thermally vaporized and diffused through the thermal vaporization/diffusion absorbent wick. Specifically, the water-based insecticidal composition is placed in a chemical liquid container, and a lower portion of the thermal vaporization/diffusion absorbent wick is put into the water-based insecticidal composition through a stopper. Thereafter, the water-based insecticidal composition in the container is transported to a top portion of the thermal vaporization/diffusion absorbent wick, is heated to 60-130° C. by a heat generator provided at a top portion of a thermal vaporization/diffusion device, and is thereby vaporized and diffused into the atmosphere. The thermal vaporization/diffusion absorbent wick faces a hollow tube-shaped heat dissipation tube included in the heat generator with a space interposed therebetween. Therefore, the desired surface temperature (e.g., 60-130° C.) of the top portion of the thermal vaporization/diffusion absorbent wick is achieved by adjusting the temperature of the heat generator to a higher temperature (e.g., 80-150° C.). If the heating temperature of the water-based insecticidal composition is excessively high, the water-based insecticidal composition is likely to be quickly vaporized and diffused, or the water-based insecticidal composition is likely to undergo pyrolysis or polymerization, leading to production of a high-boiling-point substance on the surface of the thermal vaporization/diffusion absorbent wick, which may be accumulated to clog the thermal vaporization/diffusion absorbent wick. Meanwhile, if the heating temperature is excessively low, it is difficult to vaporize and diffuse the water-based insecticidal composition, so that sufficient insect control performance cannot be achieved.

The present inventors' study has found that a positional relationship between the top portion (outer diameter: 6.7-7.3 mm) of the thermal vaporization/diffusion absorbent wick and the internal wall (inner diameter: 10 mm, height: 8-12 mm) of the heat dissipation tube facing the wick is, but indirectly, related to the entrance prevention effect of the insect pest control product. Specifically, the ratio (a/b) of a length (a) of the top portion of the thermal vaporization/diffusion absorbent wick facing the inner wall of the heat dissipation tube to a height (b) of the inner wall of the heat dissipation tube can be changed by moving the top portion of the thermal vaporization/diffusion absorbent wick upward or downward. In the insect pest control product of the present invention, the ratio (a/b) can be set within the range of 0.1-1.3. Here, if the ratio (a/b) is more than 1.0, the top portion of the thermal vaporization/diffusion absorbent wick protrudes from the top end of the heat dissipation tube. Note that if the ratio (a/b) is more than 1.0, the amount per unit time of the pyrethroid insecticidal component vaporized and diffused increases, and the uniformity of the average particle size of the diffused vapor particles adversely decreases. Therefore, it was found that particularly in the case where it is not necessary to increase the amount of the water-based insecticidal composition vaporized and diffused, it is preferable to set the ratio (a/b) to 0.2-0.8.

The thermal vaporization/diffusion device used as the insect pest control product of the present invention may be provided with various functions and members similar to those of conventional devices in addition to the above heat generator. For safety, a protective cap is provided over the heat generator. The protective cap has an opening at a center portion thereof. The size and shape of the opening may be arbitrarily determined as long as the water-based insecticidal composition does not excessively condense or adhere to the protective cap or the device. For example, to provide a cylindrical vaporization/diffusion tube having an inner diameter of 10-30 mm, hanging vertically from near the opening, is effective. In this case, the distance between the lower end of the vaporization/diffusion tube and the top surface of the heat generator is preferably typically within the range of 1-5 mm in terms of the heat resistance and vaporization/diffusion performance of the vaporization/diffusion tube. The thermal vaporization/diffusion device may be additionally provided, as appropriate, with a power supply cord, on-off operation switch, pilot light, etc., which are coupled to the heat generator.

An insect pest control method of using the insect pest control product of the present invention has practical insect killing efficacy, in indoor spaces such as living rooms, lounges, and bedrooms, on not only strains that are susceptible to pyrethroids, but also strains that have reduced susceptibility, of Culex (e.g., Culex pipiens pallens, Culex tritaeniorhynchus, Culex pipiens quinquefasciatus, and Culex pipiens molestus), Aedes (e.g., Aedes aegypti and Aedes albopictus), Chironomidae, etc, and other flying insect pests such as houseflies, drain flies, phorid flies, horseflies, black flies, and biting midges, and in addition, has the effect of efficiently preventing these insect pests from entering indoors from the outside. In particular, the insect pest control method has a significantly excellent effect of preventing mosquitoes from entering, and therefore, is considerably useful.

### EXAMPLES

Next, the insect pest control product and insect pest control method of the present invention will be described in greater detail by way of specific examples.

### Example 1

A water-based insecticidal composition was prepared by mixing 0.9 mass % of transfluthrin, 50 mass % of diethylene glycol monobutyl ether (DEMB), 0.1 mass % of dibutylhydroxytoluene (BHT) as a stabilizer, and 49 mass % of purified water.

A thermal vaporization/diffusion absorbent wick (a round bar having a diameter of 7 mm and a length of 66 mm) was obtained as follows: water was added to a mixture of 52 mass % of mica powder as an inorganic powder, 33 mass % of kaolinite powder as an inorganic binder, 10 mass % of graphite as an organic substance, 3 mass % of carboxymethyl cellulose as an organic binder, and 2 mass % of starch, followed by kneading, the kneaded mixture was extruded while pressure was applied thereto, followed by air drying and then baking at 1100° C.

Forty-five milliliters of the water-based insecticidal composition was placed in a plastic container, and the thermal vaporization/diffusion absorbent wick was put into the container through a stopper. The container was attached to a thermal vaporization/diffusion device (e.g., a device disclosed in Japanese Patent No. 2926172 or the like, which is equipped with a hollow tube-shaped heat dissipation tube (inner diameter: 10 mm, height: 10 mm, and surface temperature: 137° C.) around a top portion of the absorbent wick). Thus, an insect pest control product of Example 1 was constructed. Note that a length of the top portion of the thermal vaporization/diffusion absorbent wick facing the inner wall of the heat dissipation tube was 0.7 times as great as a height of the inner wall of the heat dissipation tube.

The insect pest control product of Example 1 was placed at the center of a 6-Jyo room (25 m³), and was used, with a window facing outdoors in one of the four side walls opened, while an electric current was passed through the heat generator for 12 hours per day. The average particle size of diffused vapor particles of the water-based insecticidal composition that were collected at a predetermined position was 1.2 μm, and the transfluthrin concentration of the diffused vapor particles at that time was 3.87 mass %, which is 4.3 times as high as the initial value 0.9 mass %. For 60 days (approximately 700 hours), no mosquitoes entered indoors through the window and bit a human.

### Examples 2-15 and Comparative Examples 1-4

Water-based insecticidal compositions and thermal vaporization/diffusion absorbent wicks used in Examples 2-15 were prepared in a manner similar to that for Example 1, and were loaded into respective thermal vaporization/diffusion devices to construct respective insect pest control products of Examples 2-15, for which measurements and tests were conducted for (1) to (4) described below. For comparison, similar measurements and tests were conducted on insect pest control products of Comparative Examples 1-4. The types and amounts of the components of the water-based insecticidal compositions and the thermal vaporization/diffusion absorbent wicks of the examples and the comparative examples, are shown in Table 1, including those of Example 1.

TABLE 1

| | | Water-based insecticidal composition (mass %) | | | | Vaporization/diffusion | | |
|---|---|---|---|---|---|---|---|---|
| | | | Glycol ether | | | absorbent wick | | |
| | | Insecticidal | compounds/glycol | Other | | | Main components | Ratio |
| | | components | compounds | components | Water | Type | (mass %) | (a/b) |
| Examples | 1 | Transfluthrin 0.9 | DEMB 50 | BHT 0.1 | Balance | Baked | Mica powder 52 | 0.7 |
| | | | | | | | Kaolinite powder 33 | |
| | | | | | | | Graphite 10, etc. | |
| | 2 | Transfluthrin 0.9 | DEMB 50 | BHT 0.1 | Balance | Baked | Mica powder 51 | 0.7 |
| | | | | | | | Kaolinite powder 35 | |
| | | | | | | | Graphite 10, etc. | |
| | 3 | Metofluthrin 0.9 | DEMB 50 | BHT 0.1 | Balance | Baked | Mica powder 51 | 0.7 |
| | | | | | | | Kaolinite powder 35 | |
| | | | | | | | Graphite 10, etc. | |
| | 4 | Profluthrin 0.9 | DEMB 50 | BHT 0.1 | Balance | Baked | Mica powder 51 | 0.7 |
| | | | | | | | Kaolinite powder 35 | |
| | | | | | | | Graphite 10, etc. | |
| | 5 | Transfluthrin 0.9 | DEMB 50 | BHT 0.1 | Balance | Baked | Talc powder 42 | 0.8 |
| | | | | | | | Bentonite 31 | |
| | | | | | | | Coke 13, etc. | |
| | 6 | Transfluthrin 0.9 | DEMIB 50 | BHT 0.1 | Balance | Braided | Polyester/polyamide | 0.4 |
| | 7 | Transfluthrin 0.9 | DEMIB 50 | BHT 0.1 | Balance | Braided | Polyester/polypropylene | 0.2 |
| | 8 | Metofluthrin 0.5 | DEMB 50 | BHT 0.1 | Balance | Baked | Polyester/polyamide | 1.0 |
| | 9 | Transfluthrin 0.9 | DPMP 70 | Tea leaf dry distilled | Balance | Baked | Mullite, etc. | 0.6 |
| | | | | solution 0.1 | | Ceramic | | |
| | 10 | Metofluthrin 0.15 | DEMB 30 | BHT 0.1 | Balance | Baked | Mullite | 0.9 |
| | | Terallethrin 0.8 | DEMIB 30 | | | Ceramic | Cordierite, etc. | |
| | 11 | Transfluthrin 0.9 | DEMPh 50 | BHT 0.1 | Balance | Baked | Talc powder 47 | 0.15 |
| | | | | Aroma chemical | | | Kaolinite powder 33 | |
| | | | | Small amount | | | Acrylic resin 11, etc. | |
| | 12 | Transfluthrin 0.9 | DEMIP 75 | BHT 0.1 | Balance | Braided | Polyester/polyamide | 0.7 |
| | 13 | Metofluthrin 0.5 | HG 30 | BHT 0.1 | Balance | Felt | Felt | 0.7 |
| | 14 | Transfluthrin 0.9 | DEMH 75 | BHT 0.1 | Balance | Braided | Polyester/polypropylene | 0.4 |
| | 15 | Metofluthrin 0.5 | DEMIP 18 | BHT 0.1 | Balance | Braided | Polyester/polyamide | 0.7 |
| Comparative | 1 | Metofluthrin 0.5 | Glycol ether A* 70 | BHT 0.1 | Balance | Braided | Polyester/polyamide | 1.0 |
| examples | 2 | Transfluthrin 0.9 | Glycol ether B** 50 | BHT 0.1 | Balance | Baked | Mica powder 51 | 0.7 |
| | | | | | | | Kaolinite powder 35 | |
| | | | | | | | Graphite 10, etc. | |
| | 3 | dl, d-T80-allethrin 2.0 | DEMB 50 | BHT 0.1 | Balance | Baked | Mica powder 51 | 0.7 |
| | | | | | | | Kaolinite powder 35 | |
| | | | | | | | Graphite 10, etc. | |
| | 4 | Transfluthrin 0.9 | Kerosene balance | BHT 0.1 | — | Baked | Mica powder 51 | 0.7 |
| | | | | | | | Kaolinite powder 35 | |
| | | | | | | | Graphite 10, etc. | |

*Glycol ether A: ethylene glycol monomethyl ether (boiling point: 124° C.)
**Glycol ether B: diethylene glycol monobenzyl ether (boiling point: 302° C.)

(1) Average Particle Size

Two plastic cylinders each having an inner diameter of 20 cm and a height of 43 cm were put on top of each other. The stack of the two cylinders was placed on a circular plate provided on a table with a rubber gasket interposed between the cylinder stack and the circular plate. The circular plate had a 5-cm circular hole at the center thereof. A thermal vaporization/diffusion device to be tested was placed on the circular hole, and heating was performed through passage of an electric current. Diffused vapor particles were captured using a microscopic glass coated with silicone oil, which was placed near an upper-end opening of the cylinder, i.e. at a position one meter away from the thermal vaporization/diffusion device. The particle size was measured by microscopy.

(2) Vaporization and Diffusion Performance

An insect pest control product to be tested was placed at the center of a 6-Jyo room (25 m³), and heating was conducted through passage of an electric current. At an early part of the period of use (day 2), diffused vapor particles were trapped using a silica gel-filled column placed at a position one meter above the thermal vaporization/diffusion device. The insecticidal component was extracted using acetone, and analyzed by gas chromatography, to determine the amount of the insecticidal component vaporized and diffused per unit time. A device identical to that described above in Section (1), except that the upper-end opening of the cylinder was hermetically sealed using a polypropylene sheet having a known weight was used, and heating was conducted through passage of an electric current for 1 h. The liquid amount of all diffused vapor particles adhering to the polypropylene sheet was measured, and the concentration of the insecticidal component in the diffused vapor particles was measured, and how many times as high that concentration is as the initial concentration of the insecticidal component was calculated.

(3) Insect Killing Efficacy Test Two plastic cylinders each having an inner diameter of 20 cm and a height of 43 cm were put on top of each other. Another cylinder having an inner diameter of 20 cm and a height of 20 cm (insects to be tested were to be placed) was put on top of the stack of the two cylinders with a 16-mesh metal mesh interposed therebetween. Still another cylinder having the same inner diameter and a height of 20 cm was put on top of the third cylinder with a similar 16-mesh metal mesh interposed therebetween. The stack of the four cylinders was placed on a circular plate provided on a table with a rubber gasket interposed between the cylinder stack and the circular plate. The circular plate had a 5-cm circular hole at the center thereof. A thermal vaporization/diffusion device was placed on the circular hole, and heating was performed through passage of an electric current. After four hours of passage of an electric current, approximately 20 adult female Culex pipiens pallens mosquitoes (insects to be tested) were released in the second uppermost cylinder, and the number of tested insects which fell down to be flat on their back as time passed was counted to calculate the KT₅₀ value. After 20 minutes of exposure, all of the tested insects were collected. The fatality rate of the insects was investigated 24 hours later. The insect killing efficacy test was conducted at an early part of the period of use (day 2) and a late part of the period of use (several days before the end of the lifespan).

(4) Entrance Prevention Ratio

A window is provided at a boundary between two adjacent 10-Jyo living rooms, which were each hermetically sealed, except for the window. An insect pest control product to be tested was placed in one of the two living rooms, and an observer spent time in that room while heating was conducted through passage of an electric current, and that room is referred to as a “chemical agent-treated section.” A hundred adult female Culex pipiens pallens mosquitoes, which were an insect to be tested, were released in the adjacent insect-released non-chemical agent section. The number of insects to be tested that entered from the insect-released non-chemical agent section into the chemical agent-treated section through the window was counted for 60 min by observation. In order to set a criterion for determination of an effect, a similar test was conducted without using an insect pest control product in a non-treated control section). The entrance prevention test was conducted twice: at an early part of the period of use (day 2); and at a late part of the period of use (several days before the end of the lifespan) of an insect pest control product to be tested. For the non-treated control section, a similar test was conducted twice. The average of the number of entering insects was calculated. An entrance prevention ratio was calculated as follows.

Entrance prevention ratio (%)=(C−T)/C×100

C: the average of the number of insects entering the non-treated control section for 60 min

T: the average of the number of insects entering the chemical agent-treated section for 60 min

The results of the measurement and test on the examples and comparative examples are shown in Table 2.

TABLE 2

| | | | Vaporization and diffusion performance | | Insect killing efficacy test | | | | | |
|---|---|---|---|---|---|---|---|---|---|---|
| | | | Vaporization | Increase factor | Early part of | | Late part of | | Entrance prevention | |
| | | Average | amount of | of insecticidal | period of use | | period of use | | ratio (%) | |
| | | particle | insecticidal | component | | Fatality | | Fatality | Early part | Late part |
| | | size | component | concentration | KT₅₀ | rate | KT₅₀ | rate | of period | of period |
| | | (μm) | (mg/h) | (times) | (seconds) | (%) | (seconds) | (%) | of use | of use |
| Examples | 1 | 1.2 | 0.55 | 4.3 | 105 | 100 | 119 | 100 | 100 | 100 |
| | 2 | 1.1 | 0.56 | 4.3 | 105 | 100 | 120 | 100 | 100 | 100 |
| | 3 | 1.3 | 0.35 | 5.4 | 104 | 100 | 116 | 100 | 94 | 88 |
| | 4 | 1.0 | 0.54 | 4.5 | 109 | 100 | 133 | 100 | 90 | 85 |
| | 5 | 0.9 | 0.51 | 5.0 | 113 | 100 | 135 | 100 | 100 | 100 |
| | 6 | 1.5 | 0.57 | 3.9 | 106 | 100 | 124 | 100 | 100 | 97 |
| | 7 | 0.5 | 0.66 | 4.8 | 98 | 100 | 142 | 100 | 100 | 100 |
| | 8 | 0.6 | 0.34 | 5.7 | 112 | 100 | 127 | 100 | 92 | 84 |
| | 9 | 0.2 | 0.60 | 4.3 | 127 | 100 | 140 | 100 | 93 | 83 |
| | 10 | 1.1 | Metofluthrin 0.11 | 7.6 | 126 | 100 | 149 | 100 | 90 | 81 |
| | | | Terallethrin 0.52 | | | | | | | |
| | 11 | 2.1 | 0.68 | 1.9 | 93 | 100 | 143 | 100 | 88 | 80 |
| | 12 | 0.15 | 0.54 | 3.0 | 90 | 100 | 162 | 70 | 87 | 73 |
| | 13 | 3.0 | 0.56 | 10.5 | 82 | 100 | 196 | 65 | 84 | 71 |
| | 14 | 1.3 | 0.61 | 1.4 | 101 | 100 | 145 | 100 | 89 | 74 |
| | 15 | 0.9 | 0.37 | 17.2 | 96 | 100 | 137 | 60 | 83 | 72 |
| Comparative | 1 | 0.3 | 0.41 | 12.1 | 96 | 100 | 194 | 50 | 74 | 43 |
| Examples | 2 | 1.3 | 0.37 | 1.7 | 175 | 60 | 210 | 45 | 76 | 45 |
| | 3 | 1.9 | 0.73 | 3.6 | 243 | 45 | 319 | 25 | 60 | 34 |
| | 4 | 0.1 | 0.55 | 1.2 | 131 | 95 | 145 | 90 | 77 | 52 |

According to the results of Tables 1 and 2, it was confirmed that the insect pest control product of the present invention has stable vaporization and diffusion performance, and excellent insect killing efficacy, and when applied to a space of a room with an open window or door in a side wall thereof, can effectively prevent flying insect pests from entering the space of the room from the outside of the room. In addition, the average particle size of diffused vapor particles was reduced from 5.0 μm immediately after being generated, to 0.2-2.5 μm, as time passed immediately after being vaporized and diffused while the particles were suspended in the room space. Meanwhile, preferable was an insect pest control product that was adjusted such that the concentration of the pyrethroid insecticidal component in the diffused vapor particles was increased to 1.5-18 times the initial concentration. In addition, a comparison between the transfluthrin formulation and the metofluthrin or profluthrin formulation shows that these formulations had substantially equal efficacies in the insect killing efficacy test, and the transfluthrin formulation particularly had an excellent entrance prevention effect. Furthermore, as the glycol ether compound and/or glycol compound, diethylene glycol monobutyl ether was preferable. In contrast to this, in the case where the boiling point of the glycol ether compound and/or glycol compound did not fall within the range of the present invention (Comparisons 1 and 2), the case where the vapor pressure of the pyrethroid insecticidal component did not fall within the range of the present invention (Comparison 3), and the case where an oil-based formulation was used instead of a water-based formulation (Comparison 4), a sufficient entrance prevention effect was not obtained.

As described above, the effect of preventing flying insect pests from entering indoors is a concept totally different from that of conventional insect killing effects, which are mainly attributed to the chemical liquid formulation. The entrance prevention effect is significantly attributed not only to the chemical liquid formulation but also to the behavior of the diffused vapor particles. Specifically, the liquid mosquito killer is adapted so that the average particle size of diffused vapor particles of the water-based insecticidal composition gradually decreases, and the pyrethroid insecticidal component concentration of the diffused vapor particles gradually increases, over time, immediately after being vaporized and diffused while the particles are suspended in a room space. The diffused vapor particles continuously form an air flow (air curtain) containing an effective amount of the pyrethroid insecticidal component at or near the inner side of a window or door. It was demonstrated that the diffused vapor particles behave so as to increase opportunities of contacting flying insect pests and enhance the effect of preventing flying insect pests from entering, and as a result, even when applied to a space of a room with an open window or door in a side wall thereof, the insect pest control product can effectively prevent flying insect pests from entering the room space from the outside of the room. Note that a reason why transfluthrin is more preferable than metofluthrin and profluthrin may be that the physical properties of transfluthrin and the proportions of the three components in the water-based insecticidal composition are beneficial to formation of an air curtain. Meanwhile, it was found that in the case where a kerosene-based formulation (oil-based formulation) was used, an insect killing effect similar to that of a water-based formulation was obtained, and the entrance prevention effect was inferior. This may be because when the average particle size of diffused vapor particles of the oil-based formulation becomes about 0.05-0.5 μm, the diffused vapor particles are easily dissipated at or near the inner side of a window or door, so that an effective air curtain is unlikely to be formed, and characteristic beneficial effects of the water-based formulation such as an increase in the concentration of the pyrethroid insecticidal component in the diffused vapor particles are not obtained.

### INDUSTRIAL APPLICABILITY

The present invention is applicable as an insect pest control product for humans and pets, and has other applications, such as insecticidal, acaricidal, sterilizing, antimicrobial, deodorizing, and antibromic applications.

1. An insect pest control product comprising a thermal vaporization/diffusion absorbent wick for vaporizing and diffusing a water-based insecticidal composition containing a pyrethroid insecticidal component having a vapor pressure of 2×10⁻⁴ to 1×10⁻² mmHg at 30° C., a glycol ether compound and/or glycol compound having a boiling point of 150-300° C., and water,
wherein
a concentration of the pyrethroid insecticidal component in diffused vapor particles one hour after the start of vaporization and diffusion is 1.5-18 times as high as a concentration of the pyrethroid insecticidal component in diffused vapor particles immediately after the start of vaporization and diffusion.

2. The insect pest control product of claim 1, wherein
the diffused vapor particles one hour after the start of vaporization and diffusion have an average particle size of 0.2-2.5 μm.

3. The insect pest control product of claim 1, wherein
the glycol ether compound is diethylene glycol monoalkyl ether.

4. The insect pest control product of claim 1, wherein
the pyrethroid insecticidal component is at least one selected from the group consisting of transfluthrin, metofluthrin, and profluthrin.

5. The insect pest control product of claim 1, further comprising:
a hollow tube-shaped heat generator for heating the thermal vaporization/diffusion absorbent wick with the heat generator surrounding the absorbent wick,
wherein
a height of a region where an outer surface of the thermal vaporization/diffusion absorbent wick and an inner surface of the hollow tube-shaped heat generator face each other is set to 0.2-0.8 times as great as a length of the hollow tube-shaped heat generator.

6. The insect pest control product of claim 1, wherein
a surface temperature of the hollow tube-shaped heat generator is set to 80-150° C., and
an average gap distance between an outer surface of the thermal vaporization/diffusion absorbent wick and an inner surface of the hollow tube-shaped heat generator is set to 1.2-1.8 mm.

7. The insect pest control product of claim 1, wherein
a length of the hollow tube-shaped heat generator is set to 8-12 mm.

8. The insect pest control product of claim 1, wherein
the thermal vaporization/diffusion absorbent wick is a baked wick, a porous ceramic wick, a felt wick, or a braided wick.

9. The insect pest control product of claim 1, wherein
the water-based insecticidal composition vaporized and diffused from the thermal vaporization/diffusion absorbent wick prevents a flying insect pest from entering a room from the outside of the room.

10. The insect pest control product of claim 1, wherein
the insect pest control product is for preventing a flying insect pest from entering a room of at least 25 m³ from the outside of the room for 30-90 days.

11. An insect pest control method of using the insect pest control product of claim 1, comprising:
putting the thermal vaporization/diffusion absorbent wick in the water-based insecticidal composition so that the water-based insecticidal composition is absorbed and transported to a top portion of the thermal vaporization/diffusion absorbent wick, and heating the top portion of the thermal vaporization/diffusion absorbent wick at 80-150° C. so that the pyrethroid insecticidal component is vaporized and diffused into the atmosphere.
